(19) United States
(12) Patent Application Publication
(10) Pub. No.: US 2017/0019615 A1
(43) Pub. Date: Jan. 19, 2017

(54) IMAGE PROCESSING METHOD, NON-TRANSITORY COMPUTER-READABLE STORAGE MEDIUM AND ELECTRICAL DEVICE THEREOF

(71) Applicant: ASUSTeK COMPUTER INC., Taipei (TW)

(72) Inventors: PO-YU YEH, Taipei (TW); PO-YUAN YEH, Taipei (TW); WAN-PANG CHANG, Taipei (TW)

(21) Appl. No.: 15/202,676

(22) Filed: Jul. 6, 2016

Related U.S. Application Data
(60) Provisional application No. 62/191,538, filed on Jul. 13, 2015.

(30) Foreign Application Priority Data
May 24, 2016 (TW) 105116170

(51) Int. Cl. H04N 5/347; H04N 5/351; G06T 5/00; G06T 5/20; H04N 5/232; G06T 3/40

(52) U.S. Cl. CPC H04N 5/347; H04N 5/23232; G06T 3/4053; G06T 3/4007; G06T 5/002; G06T 5/20; H04N 5/351

(57) ABSTRACT

An image processing method is provided. The image processing method comprises obtaining at least one original image; performing a pixel binning progress on the original image; continuously obtaining a plurality of the first images processed by the pixel binning progress; and performing a super resolution reconstruction process on the first images via an interpolation method to generate a second image. The pixel binning progress makes pixel signals for a plurality of adjacent pixels in the original image combined into a new pixel signal to generate a first image with the new pixel signal. A non-transitory computer-readable storage medium and an electronic device for performing the method are also provided.

### CROSS-REFERENCE TO RELATED APPLICATION

This application claims the priority benefit of U.S. provisional application Ser. No. 62/191,538, filed on Jul. 13, 2015 and TW application serial No. 105116170, filed on May 24, 2016. The entirety of the above-mentioned patent applications are hereby incorporated by references herein and made a part of specification.

### BACKGROUND OF THE INVENTION

Field of the Invention

The disclosure relates to an image processing method and, more specifically, to an image processing method applied in a low-light environment.

Description of the Related Art

Nowadays, electronic devices, such as mobile phones, tablet computers and notebooks, are usually equipped with a photographic device for capturing images. However, the images taken in a low-light environment are too dark with many noises.

### BRIEF SUMMARY OF THE INVENTION

According to a first aspect of the present disclosure, an image processing method comprises: obtaining at least one original image; performing a pixel binning progress on the original image, wherein the pixel binning progress is used for combing a plurality of adjacent pixel signals in the original image into a new pixel signal to generate a first image with the new pixel signal; continuously obtaining a plurality of the first images with the new pixel signal; and performing a super resolution reconstruction process on the first images by an interpolation method to generate a second image.

According to a second aspect of the disclosure, a non-transitory computer-readable storage medium for storing a computer program, after the computer program is loaded on an electronic device, an image processing method is performed by the electronic device, the image processing method comprises: obtaining at least one original image; performing a pixel binning progress on the original image, wherein the pixel binning progress is used for combing a plurality of adjacent pixel signals in the original image into a new pixel signal to generate a first image with the new pixel signal; continuously obtaining a plurality of the first images with the new pixel signal; and performing a super resolution reconstruction process on the first images by interpolation method to generate a second image.

According to a third aspect of the disclosure, an electronic device comprises: an image capturing unit for outputting an original image or combining a plurality of adjacent pixel signals in the original image into a new pixel signal to generate a first image with the new pixel signal; and a processor connected to the image capturing unit for continuously obtaining a plurality of the first images and generating a second image from the first images by an interpolation method.

In sum, in embodiments, the brightness of the image is enhanced via the pixel binning process, and then the image is reconstructed via the super resolution reconstruction process to restore the original resolution of the image. Therefore, images taken in the low-light environment are bright enough without reducing the resolution.

### BRIEF DESCRIPTION OF THE DRAWINGS

These and other features, aspects and advantages of the disclosure will become better understood with regard to the following embodiments and accompanying drawings.

FIG. 1 is a flow chart of an image processing method in an embodiment;

FIG. 2 is a block diagram showing an electronic device in an embodiment;

FIG. 3 is a schematic diagram showing an original image in an embodiment; and

FIG. 4 is a flow chart of details of step 140 in FIG. 1.

### DETAILED DESCRIPTION OF THE EMBODIMENTS

Multiple embodiments are disclosed below accompanying with the figures. For clarity, details in practice will also be described hereinafter. However, it should be understand that the details in practice are not used for limiting the disclosure. In other words, in some of the embodiments, the details in practical are not essential. Additionally, for concise illustration, some commonly-used components or structures in the art are shown simply in the figures.

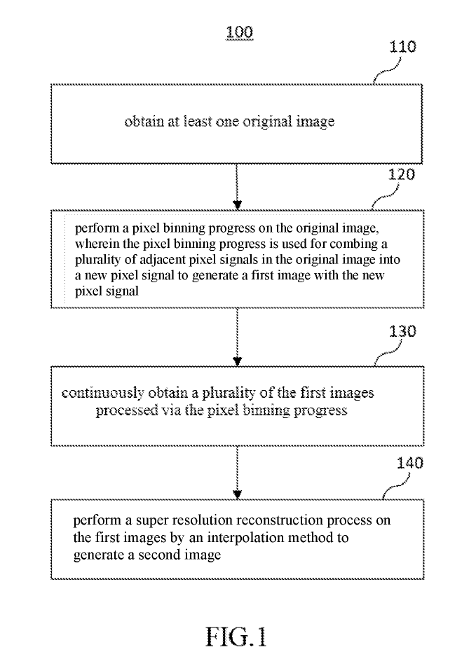

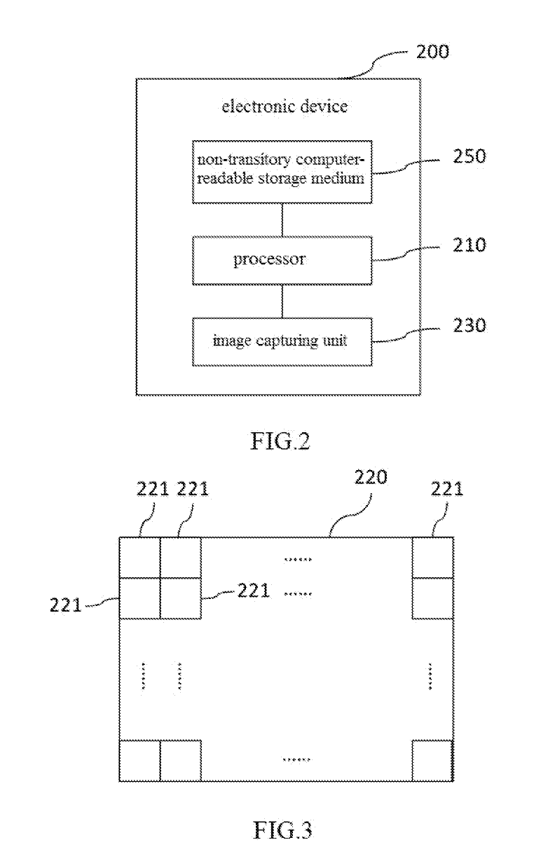

FIG. 1 is a flow chart of an image processing method 100 in an embodiment. FIG. 2 is a block diagram showing an electronic device 200 in an embodiment. Please refer to FIG. 1 and FIG. 2, an image processing method 100 is adapted to an electronic device 200. The electronic device 200 includes a processor 210 and an image capturing unit 230 that are electrically connected relatively. In the embodiment, the image capturing unit 230 is a camera module for outputting an original image.

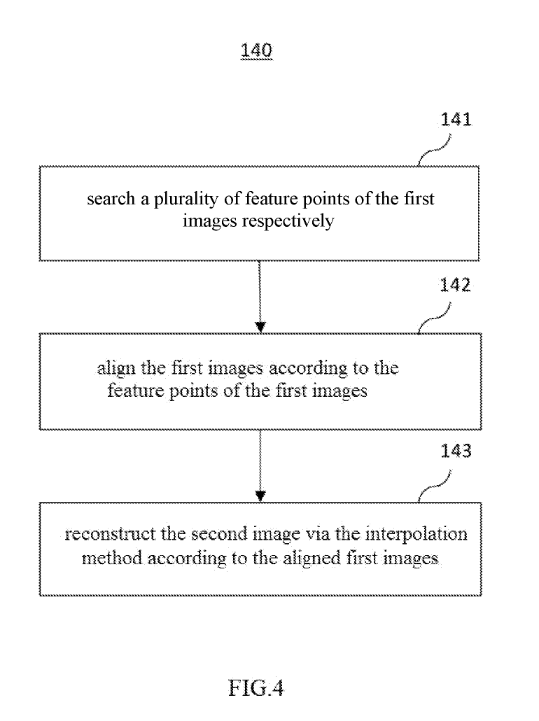

FIG. 3 is a schematic diagram showing an original image 220 in an embodiment. As shown in FIG. 3, an original image 220 includes a plurality of pixels 221. For clarity, only part of the pixels 221 is shown in a magnified view.

In the embodiment, the electronic device 200 is, but not limited to, a smart phone, a tablet computer or a notebook computer, or other electronic devices that are capable of capturing images. The electronic device 200 further includes a non-transitory computer-readable storage medium 250 connected to the processor 210. The non-transitory computer-readable storage medium 250 is, but not limited to, a read-only memory, a flash memory or a hard disk. Computer programs are stored in the non-transitory computer-readable storage medium 250. The image processing method 100 is performed by the processor 210 of the electronic device 200.

Please refer to FIG. 1, in step 110, the processor 210 receives at least one original image captured by the image capturing unit 230. Then, the processor 210 sends a pixel binning command to the image capturing unit 230 to perform a pixel binning progress on the original image (step 120). The pixel binning progress is used for combining a plurality of adjacent pixel signals 221 (four adjacent pixel signals in the embodiment) into a new pixel signal to generate a first image with the new pixel signal. The term “combining” herein refers to the four pixel signals that added into the new pixel signal. Thus, after step 120, the brightness of the first image is four times higher than that of the original image. However, the resolution of the first image resulted from the pixel binning progress is four times lower than that of the original image. Then, next step is performed to restore the original resolution of the image.

In an embodiment, whether the pixel binning process is executed is determined according to a practical filming environment. That is, before step 120, the processor 210 determines an ambient brightness according to the original image received from the image capturing unit, and then whether the image capturing unit needs to perform the pixel binning progress on the original image is determined according to the ambient brightness. In an embodiment, a parameter of the ambient brightness is sensed by an ambient light sensor configured at the electronic device 200. The processor 210 receives the parameter of the ambient brightness from the ambient light sensor, and determines whether to output a pixel binning command according to the parameter of the ambient brightness. That is, if the parameter of the ambient brightness is less than a preset value, a low-light environment is determined. Then, step 120 is performed and the processor 210 outputs the pixel binning command to the image capturing unit 230 to perform the pixel binning progress to output a first image. Conversely, if the parameter of the ambient brightness is not less than the preset value, the filming environment is not a low-light environment, then, the image capturing unit 230 outputs the original image to the processor 210 directly without the pixel binning progress. A super resolution reconstruction process also can be executed on the multiple continuous original images by the processor 210.

In step 130, after steps 110 to 120 are repeatedly performed by the processor 210, a plurality of the first images that are processed by the pixel binning process are continuously obtained. The continuous first images refer to those images that are taken in short time intervals (such as 1/30 second). The time intervals are different in an embodiment. In an embodiment, the number of the first images is more than four to provide enough data for the subsequent steps.

Then, in step 140, the processor 210 performs a super resolution reconstruction process to the first images by an interpolation method to generate a second image. The second image has the same resolution as the original image. Please refer to FIG. 4, FIG. 4 is a flow chart of details of step 140 in FIG. 1. First, multiple feature points of the first images, such as at edges, corners, speckles and ridges, are searched (step 141). The feature points are selected by using a Harris detection method, a FAST detection method, a SURF detection method, a SIFT detection method or a MSER detection method. Then, since the electronic device 200 is hold by the user, the captured view of the first images might be slightly different from each other. Shift information of each first image is calculated according to the location of a same feature point in the first images. The first images are aligned by moving the same feature point of the respective first images to a same coordinate point (step 142). After the alignment, a pixel at any location is surrounded by other pixels from different first images, and a second image is formed by reference to the location information and color information of these pixels together by an interpolation method or a median filter method (step 143). In the embodiment, the interpolation method is a non-iterative interpolation method. That is, the interpolation method, such as a linear interpolation method, is completed by one-time operation.

In an embodiment, some of the above steps are performed by the image capturing unit 230. In an embodiment, in step 110, images are captured by the image capturing unit 230 to obtain the original images. In step 120, the pixel binning progress is executed by the image capturing unit 230 to generate the first images, and the first images are output to the processor 210 from the image capturing unit 230. Then, the processor 210 executes the step 130 and next steps.

In an embodiment, after step 140, some edges of the second image are usually having blurring and aliasing problems. Then, the second image is smoothed via an image smoothing filter to overcome the blurring and aliasing problems of the edges of the second image. In the embodiment, the image smoothing filter is, but not limited to, a Bilateral Filter, a Trilateral Filter or a Guided Image Filter.

In an embodiment, the first images that are processed by the pixel binning process have many noises. Therefore, before step 140, the first images are smoothed via an image smoothing filter. Similarly, the image smoothing filter is, but not limited to, a Bilateral Filter, a Trilateral Filter or a Guided Image Filter. As a result, the quality of the second image generated in step 140 is better.

In sum, in the embodiments, the brightness of the image is enhanced via the pixel binning process, and then the image is reconstructed via the super resolution reconstruction process to restore the original resolution of the image. Therefore, images taken in the low-light environment are bright enough without reducing the resolution.

Although the disclosure has been disclosed with reference to certain embodiments thereof, the disclosure is not for limiting the scope. Persons having ordinary skill in the art may make various modifications and changes without departing from the scope of the disclosure. Therefore, the scope of the appended claims should not be limited to the description of the embodiments described above.

What is claimed is:

1. An image processing method comprising:
obtaining at least one original image;
performing a pixel binning progress on the original image, wherein the pixel binning progress is used for combing a plurality of adjacent pixel signals in the original image into a new pixel signal to generate a first image with the new pixel signal;
continuously obtaining a plurality of the first images with the new pixel signal; and
performing a super resolution reconstruction process on the first images by an interpolation method to generate a second image.

2. The image processing method according to claim 1, wherein the step of performing the super resolution reconstruction process to the first images by the interpolation method to generate the second image further comprises:
searching a plurality of feature points of the first images respectively;
aligning the first images according to the feature points of the first images; and
reconstructing the second image by the interpolation method according to the aligned first images.

3. The image processing method according to claim 1, wherein after the step of performing the super resolution reconstruction process, the method further comprises:
smoothing the second image via an image smoothing filter.

4. The image processing method according to claim 1, wherein before the step of performing the super resolution reconstruction process, the method further comprises:
smoothing the first images via an image smoothing filter.

5. A non-transitory computer-readable storage medium for storing a computer program, after the computer program is loaded on an electronic device, an image processing method is performed by the electronic device, the image processing method comprising:
obtaining at least one original image;
performing a pixel binning progress on the original image, wherein the pixel binning progress is used for combing a plurality of adjacent pixel signals in the original image into a new pixel signal to generate a first image with the new pixel signal;
continuously obtaining a plurality of the first images with the new pixel signal; and
performing a super resolution reconstruction process on the first images by interpolation method to generate a second image.

6. The non-transitory computer-readable storage medium according to claim 5, wherein the step of performing the super resolution reconstruction process on the first images by the interpolation method to generate the second image further comprises:
searching a plurality of feature points of the first images respectively;
aligning the first images according to the feature points of the first images; and
reconstructing the second image by the interpolation method according to the aligned first images.

7. The non-transitory computer-readable storage medium according to claim 5, wherein after the step of performing the super resolution reconstruction process, the method further comprises:
smoothing the second image via an image smoothing filter.

8. The non-transitory computer-readable storage medium according to claim 5, wherein before the step of performing the super resolution reconstruction process, the method further comprises:
smoothing the first image via an image smoothing filter.

9. An electronic device comprising:
an image capturing unit for outputting an original image or combining a plurality of adjacent pixel signals in the original image into a new pixel signal to generate a first image with the new pixel signal; and
a processor connected to the image capturing unit for continuously obtaining a plurality of the first images and generating a second image from the first images by an interpolation method.

10. The electronic device according to claim 9, wherein the processor determines an ambient brightness according to the original images received from the image capturing unit, and determines whether to make the image capturing unit output the first images according to the ambient brightness.

11. The electronic device according to claim 9, wherein the first images or the second image are smoothed by the processor.
